(19) United States
(12) Patent Application Publication
(10) Pub. No.: US 2004/0111480 A1
(43) Pub. Date: Jun. 10, 2004

(54) Message screening system and method

(76) Inventor: Jonathan Zhanjun Yue, San Ramon, CA (US)

Correspondence Address: Kevin J. McNeely, Esq., 5301 Wriley Road, Bethesda, MD, 20816, US

(21) Appl. No.: 10/697,017

(22) Filed: Oct. 31, 2003

Related U.S. Application Data
(60) Provisional application No. 60/432,118, filed on Dec. 9, 2002.

(51) Int. Cl. G06F 15/16

(52) U.S. Cl. 709/206; 709/245

(57) ABSTRACT

A method of screening a message includes conveying a first electronic message from a unique public address of a receiver to a unique private address of the receiver and delivering the conveyed first electronic message from the private address to a receiver address. The electronic message may be an email and the addresses may be email addresses.

### CROSS REFERENCE TO RELATED APPLICTIONS

This application claims priority from U.S. Provisional Application No. 60/432118, filed Dec. 9, 2002, which is incorporated herein by reference.

### FIELD OF THE INVENTION

The present invention relates generally to screening electronic messages, and more particularly, to blocking spam or undesirable electronic mail solicitations.

### BACKGROUND

Many electronic mail (email) users have suffered from unsolicited junk email messages. An efficient way for an email user to block junk email messages is to use a Whitelist that includes a list of permissible email addresses. Email messages sent from email addresses that are not included in the whitelist are rejected or saved in a special email folder.

The whitelist of an email user can also include other information such as name, phone number, and public key or certificate in the Public Key Infrastructure (PKI) architecture.

The challenge with the whitelisting method is that it is difficult for new email users to communicate with a user who uses a whitelist. Since the new email user is not yet included in a recipient's whitelist, the recipient will not be able to receive email messages from the new email user properly. The email messages would be rejected immediately or would be mixed together with other junk email messages depending on how the recipient handles junk email. As a result, it is impossible or unreliable for one email user to include its email address in recipient's whitelist through email communication. The new email user might have to resort to other means such as telephone or written notice to communicate with the recipient so that the recipient can include the new user's email address into recipient's whitelist.

### SUMMARY

The invention presented herein provides a method for one user to “subscribe” himself/herself to the email whitelist of another email user. In other words, the method allows one email user to have his/her email address included in another email user's whitelist if the other email user elects to do so. The Whitelist subscription is a one-time process for an email user. Once the subscription is successful, the user can send email directly to the recipient using the normal email system.

In one general aspect, a method of screening a message includes conveying a first electronic message from a unique public address of a receiver to a unique private address of the receiver and delivering the conveyed first electronic message from the private address to a receiver address. The electronic message may be an email and the address may be email addresses.

Implementation may include one or more of the following features. For example, the method may further include assigning the public address and the private address to the receiver. In another implementation, the method may include terminating the public address after a time period, rejecting a second message sent to the terminated public address, and/or replacing the terminated public address with a new unique public address.

In another implementation, the method may include assigning a unique mail uniform resource identifier, such as, for example, a uniform resource locater, to the receiver and receiving a third electronic message at the mail uniform resource identifier. Delivering may include delivering the third electronic message from the mail uniform resource identifier to the receiver address if a sender of the third message recognizes an image pattern.

The method may further include presenting an online form to the sender, the online form including the image. If the image pattern is recognized, the delivering includes retrieving the private address associated with the mail uniform resource identifier and delivering the third electronic message to the receiver address with the private address as a sender address.

In a further implementation, the method may include registering the receiver having the receiver address and providing a user account to the registered receiver, wherein the user account comprises the private address and the public address. Providing the user account may include requesting entry of a unique user identification and a password and the method may further include allowing access to the user account with the user identification and the password. Providing the user account also may include determining whether the requested user identification is an email account to be protected and requesting an email address of the email account to be protected if the requested user identification is not the email account to be protected.

In another implementation, the method may include establishing a list of approved senders. Delivering may include only delivering a message if a sender is one of the approved senders and including the private address in the list of approved senders during the registering the receiver. The list of approved senders may include a whitelist.

In another general aspect, a computer program that screens electronic messages includes a first code segment to assign a unique mail uniform resource identifier and a unique private address to a receiver, a second code segment to receive an electronic message at the mail uniform resource identifier, and a third code segment to deliver the electronic message from the mail uniform resource identifier to an address of the receiver with a sender address that includes the private address if a sender of the third message recognizes an image pattern.

Implementation may include one or more of the features described above.

In a further general aspect, a message screening system may include a database having a list of approved senders, an email agent module configured to provide an email user with a private agent having a private agent email address and a public agent having a public agent email address, a mail transfer module that transfers an email message from the public agent to the private agent, and a mail delivery module that delivers the email message from the private agent to an address of the email user if the private agent email address is included in the list of approved senders. Implementation may include one or more of the features described above.

### DESCRIPTION OF THE DRAWINGS

FIG. 1 schematically depicts an illustrative network where an Email Agent Center is used for Whitelist subscription.

FIG. 2 depicts the components in an Email Agent Center of the preferred embodiment of the present invention.

FIG. 3 illustrates exemplary agent centers used in local area network and wide area networks.

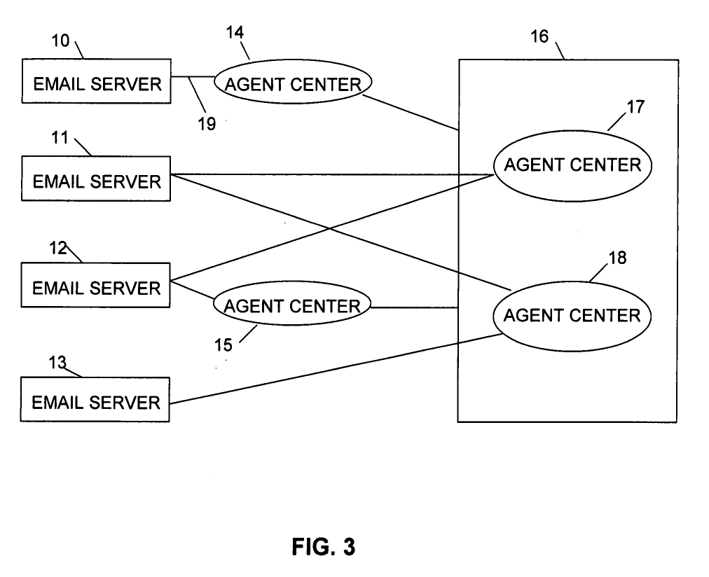

FIG. 4 is a flow chart showing the control flow of email whitelist subscription among email users using the agent center.

FIG. 5 is a flowchart illustrating the process and methods of assigning public and private agents to email users by an agent center.

FIG. 6 is an illustrative flowchart showing the procedure and methods of a user sending whitelist subscription message to another user via an agent center.

FIG. 7 is a flowchart showing the procedure and methods of a program sending email message to an email user via an agent center.

FIG. 8 is a flowchart illustrating the procedure and methods to block junk email messages in which the sender's email address is the same as the recipient's email address.

### DETAILED DESCRIPTION

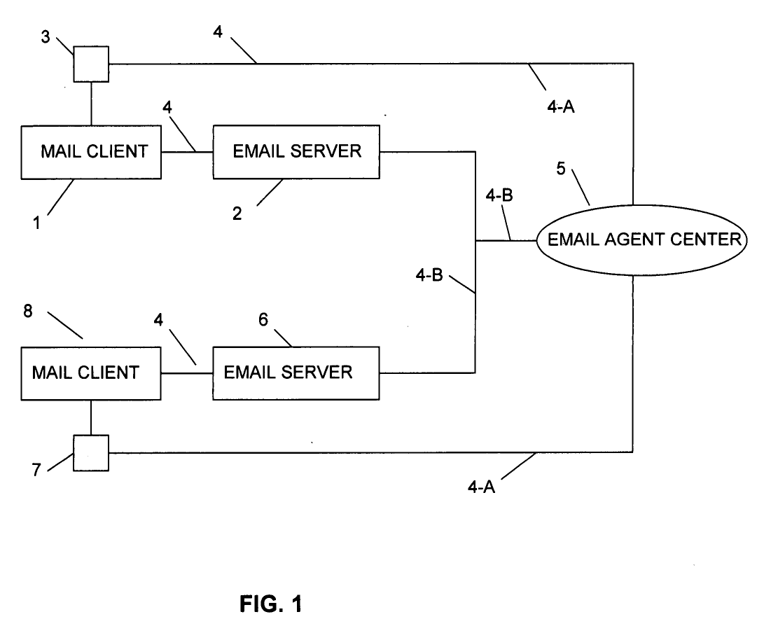

FIG. 1 schematically depicts an illustrative network where an Email Agent Center (agent center) is used for whitelist subscription. The lines 4, 4-A, 4-B are communications lines. Mail client 1 is a Mail User Agent (MUA) that can be used by one or more email users to manage email messages. Email servers 2 and 6 are computer servers responsible for transferring and delivering email messages.

Each mail server can have a Mail Transfer Agent (MTA) and a Mail Delivery Agent (MDA). The terms MUA, MTA, and MDA are defined in the well-known Simple Mail Transfer Protocol (SMTP). Network segments marked 4-B are capable of conducting electronic messaging with the SMTP standard. An Email Agent Center 5 is connected to the email servers 2 and 6 and to the email users 1 and 7.

Email user 7 uses mail client 8 to receive email and uses an email whitelist. User 3 registers with the agent center 5 through communication line 4-A. In one embodiment of the present invention, line 4-A is capable of electronic communication with the Hyper Text Transfer Protocol (HTTP). Preferably the agent center 5 provides a HTTP server and the users 3 and 7 use a Web browser to access the HTTP server.

Via agent center 5, email user 3 can subscribe to the whitelist of user 7 and vice versa. When the two users are mutually subscribed to each other's whitelist, they can send email to each other directly with normal email.

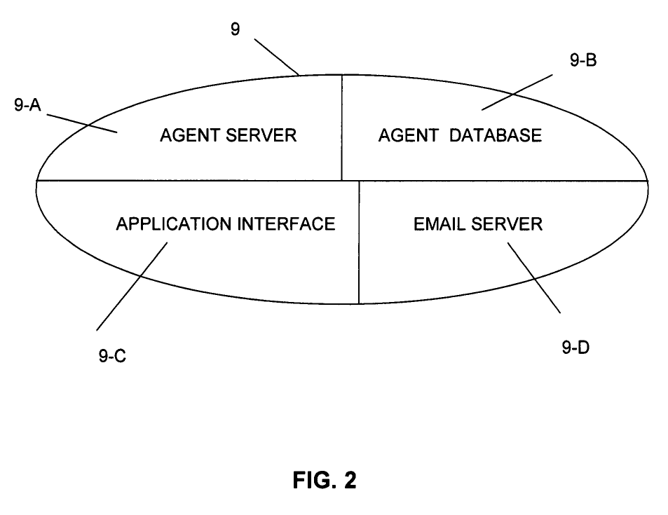

FIG. 2 shows the components in an Email Agent Center 9. Agent Server 9-A accepts requests from email users and provides services to the users. In the illustrated embodiment of the present invention, the agent server is a HTTP server. Other embodiments include servers that are compliant to the Simple Object Access Protocol (SOAP), Extended Markup Language (XML) protocol, or any other communication protocol. Agent Database 9-B is a database storing the records of all registered users. The following parameters of a registered user are included in a database record:

{User ID, Password, Email Address, Private Agent, Public Agent, Expiry Date}.

User ID is a unique user identification (ID) name. Password is a secret word or phrase entered by the user for later logon to the agent center. Email Address is the user's email address that will be protected from receiving junk email. Private Agent includes a secret email address created by the agent center and assigned to the registered user. The private agent should be trusted by the user and never disclosed to other email users. Public Agent includes an email address that can be disclosed to selected email users such as e-commerce Web sites or online service providers. The email address of the Public Agent is a temporary email address, which can expire after a period of time specified by the user. The selected email users can send regular email messages to the public agent. The agent center that “owns” the public agent will forward the messages to the intended recipient as if the email messages were sent from the recipient's private agent. The Expiry Date is the expiration date after which the public agent will be made invalid by the agent center. When a public agent is expired, email messages addressed to it are rejected by the agent center. The registered email user can log in to the agent center and request a new public agent at any time.

Referring to FIG. 2 again, Application Interface 9-C represents other communication channels to the agent center. These channels include telephone communications, FAX messages, TCP/IP socket programming interfaces, etc.

Application Interface 9-C is complimentary to the agent server 9-A. Email server 9-D is a server for sending email messages to registered users.

FIG; 3 depicts an exemplary block diagram where a multiplicity of agent centers reside in local area network (LAN) and wide area network (WAN). The physical infrastructure of communication networks LAN and WAN can be wired lines or wireless transmissions. Email users served by mail server 10 are registered with agent center 14. Agent center 14 is connected with mail server 10 through LAN 19 and connected to WAN 16. Email server 11 uses agent centers 17 and 18 that are located on WAN 16. Note that email server 11 does not use an agent center on its own local area network. Email server 12 uses agent center 15 on the local area network and agent center 17 on the wide area network 16. Email server 13 uses only an agent center 18 residing on the wide area network.

When an email server is said to “use” an agent center herein, the email users served by the mail server are recommended to register with the agent center.

However, some users may elect not to register with the recommended agent center. They can register with agent centers that reside on the network (LAN or WAN) that are available and accessible to them. Selecting which agent center to use is at an email user's discretion.

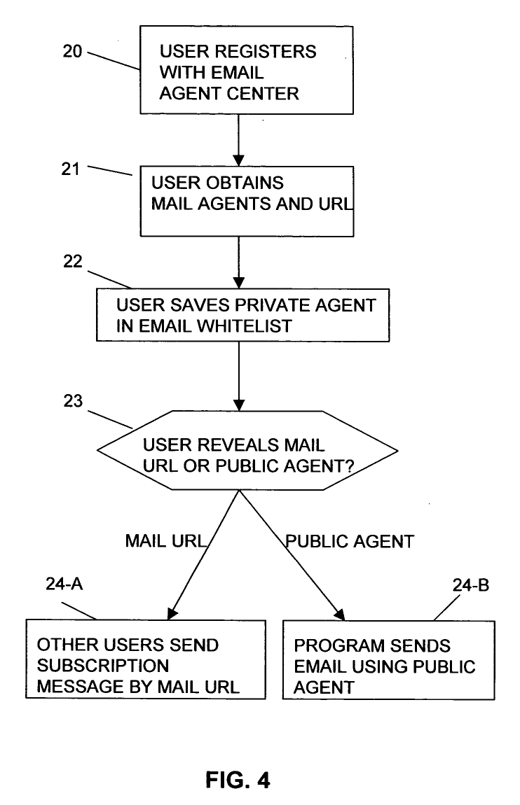

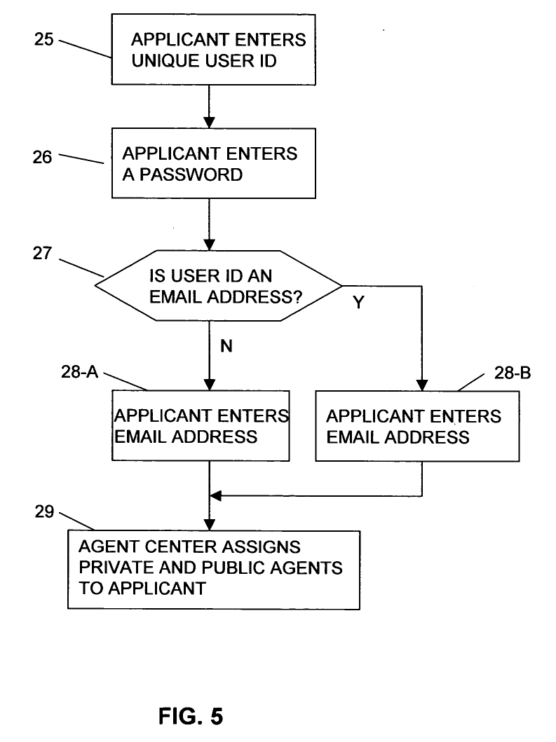

FIG. 4 is a flow chart showing the control flow of a whitelist subscription process among email users using the Email Agent Center. At step 20, an email user who uses a whitelist first registers with an agent center. Detailed steps of the registration will be described in FIG. 5.

When the user registers with the agent center, the user selects a unique ID string and a password. The agent center creates a user account (not an email account) for the email user who can use the ID and the password to log in to the agent center and manage his/her account. The user can elect to use an email address as the ID string. After successful registration, the user obtains a unique uniform resource identifier (URI), such as, for example, a Mail URL (MURL). In the preferred embodiment of the present invention, the Mail URL has the following format:

http://<www.AgentCenterDomain>/<UserID>

where <www.AgentCenterDomain> represents the full URL (including the port number) of the HTTP server in the agent center. If secure socket layer (SSL) protocol is required by the HTTP server, “http” must be replaced by “https”.

A particular case with the Mail URL is that it may include an email address such as:

http://<www.AgentCenterDomain>/<UserEmailAddress>

where <UserEmailAddress>is an email address used by the user as his/her account user ID.

Upon successful registration, the email user obtains a private agent and a public agent as shown in step 21. In the preferred embodiment of the present invention, the information of the agents are provided by a HTTP server and displayed in a Web browser. The private agent is uniquely represented by an email address as follows:

<PrivateAgent>@<AgentCenterDomain>

where <PrivateAgent> is a unique identification (ID) string generated by the agent center. The ID string can be a randomly generated string or an encoded string. Characters in <AgenterCenterDomain> is the domain name of the agent center.

The public agent is also represented by a unique email address:

<PublicAgent>@<AgentCenterDomain>

where <PublicAgent> is a unique ID string similar to the string <PrivateAgent> and <AgentCenterDomain> represents the domain name of the agent center.

At step 22 shown in FIG. 4, the registered email user saves the private agent's email address in his/her whitelist so that the user will be able to receive email messages sent from his/her private agent.

At step 23, the registered user reveals his/her email contact information to friends, on name cards, online service providers, e-commerce web sites, etc. If the user expects the other email user would send email manually, i.e., not programmatically, the user will reveal his/her Mail URL to other email users such as friends and business contacts. If the user is filling out an online form required by an online service provider or e-commerce web site, the user can elect to enter the email address of his/her public agent.

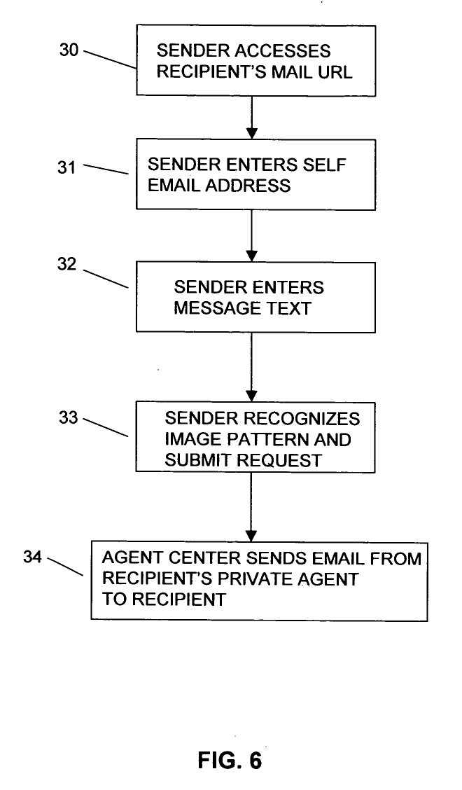

At step 24-A, other email users who have obtained the Mail URL of the registered user can send a whitelist subscription message to the registered user via the agent center. Detailed steps of this procedure will be described in FIG. 6.

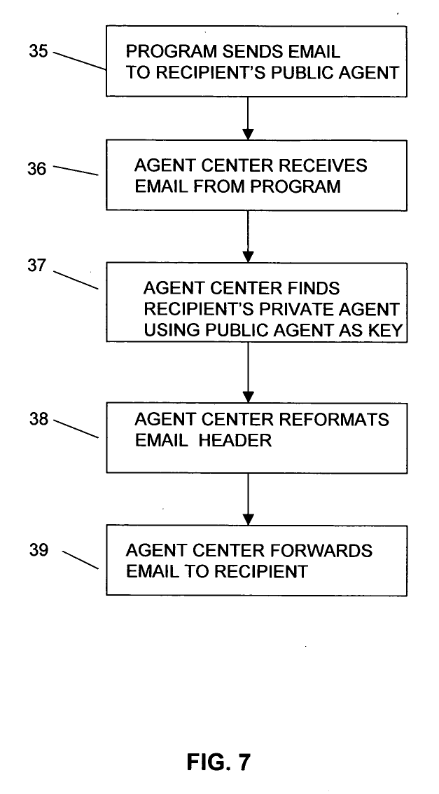

At step 24-B, a computer program can send a regular email message to the public agent of the registered user. When the agent center receives the message, it forwards the message to the registered user. Detailed descriptions of this procedure will be illustrated in FIG. 7.

FIG. 5 is a flow chart that illustrates the procedure and detailed steps for an email user to register with an agent center. An email user who wishes to register with the agent center is herein referred to as an “applicant”. In the illustrated embodiment of the present invention, the user accesses a Web site provided by the agent center using a Web browser. At step 25, the applicant inputs a unique ID string in the applicant's choice. This ID string can be an email address if the applicant chooses to display his/her email address in his/her Mail URL. At step 26, the applicant enters a secret password string.

At step 27, the agent center determines if the ID string entered by the user is an email address. If the answer is NO, the agent center asks the applicant to input the email address to be protected from receiving junk email. If the result is YES, the control goes to step 28-B where the agent center prompts the applicant to enter the protected email address. The user can designate the email address in the ID string as the protected email address or enter a different email address as the protected email address. After validating all the input from the applicant (ID string, password, email address), at step 29, the agent center assigns unique private and public agents to the applicant by displaying the email addresses of the assigned agents to the applicant and storing the agents into the agent database.

The default value of the expiry date for the public agent is stored in the database.

FIG. 6 is a flow chart illustrating the procedure and methods for a sending email user (sender) to send a whitelist subscription message to a recipient who is registered with an agent center. In the illustrated embodiment of the invention, at step 30, the sender accesses the Mail URL of the recipient using a Web browser.

An online form is presented to the sender for data input. At step 31, the sender enters his/her email address on the form. At step 32, the sender enters email message.

At step 33, the sender is required to recognize the pattern of an image generated dynamically by the agent center and displayed to the sender. The pattern could be a string of letters, digits, or shapes of objects. The sender must recognize the pattern in the image and enter the correct answer. The pattern recognition measure is to prevent junk-email senders from using computer programs to send email messages to the recipient automatically. All the dynamically-generated patterns are intentionally made hard for computer programs to obtain the correct answer, while humans can easily recognize the patterns correctly.

The sender then requests to send the email message to the recipient, usually by pressing a “Submit” button on the online form. At step 34, the agent center constructs a SMTP mail and uses its mail server to send the email to the recipient. Because the Mail URL accessed by the sender contains the recipient's unique user ID, the agent center can use this user ID to find the recipient's private agent by looking up the agent database. The agent center formats the SMTP mail header by placing the private agent's email address on the “From:” header field as if this email was sent from the recipient's private agent. An exemplary SMTP mail header of such email is shown as follows:

From: <RecipientPrivateAgentEmailAddress>

To: <RecipientEmailAddress>

Reply-To: <SenderEmailAddress>

Subject: Email Address Registration Request

where <RecipientPrivateAgentEmailAddress> represents the email address of the recipient's private agent; <RecipientEmailAddress> is the email address of the recipient stored in the agent database; <SenderEmailAddress> is the email address entered by the sender in step 31. The message text entered by the sender in step 32 is copied to the message body of the SMTP mail. The recipient's mail server should receive the email and deliver it to the recipient properly.

FIG. 7 is a flow chart showing the procedure and methods that are used by a computer program to send email messages to a registered recipient via the agent center. At step 35, the program sends a regular email addressed to the public agent of the registered recipient. At step 36 the agent center receives the email because the public agent belongs to the same domain as the agent center. At step 37, the agent center determines the public agent from the received email and then performs a look up in the agent database. When it looks up in the database, it finds the private agent and recipient's email address corresponding to the public agent.

At step 38 of FIG. 7, the agent center constructs a SMTP mail and uses its mail server to send the email to the recipient's email address. The agent center formats the SMTP mail header by placing the private agent's email address on the “From:” header field as if the email was sent from the recipient's private agent. An exemplary SMTP mail header of such email is shown as follows:

From: <RecipientPrivateAgentEmailAddress>

To: <RecipientEmailAddress>

Reply-To: <ProgramSenderEmailAddress>

Subject: Email From Your Public Agent

where <RecipientPrivateAgentEmailAddress> represents the email address of the recipient's private agent; <RecipientEmailAddress> is the recipient's email address stored in the agent database; <ProgramSenderEmailAddress> is the email address of the original sender (the program). The message text sent by the program is copied to the message body of the SMTP mail.

After the recipient receives the email, the recipient can elect to save the <ProgramSenderEmailAddress> to the recipient's whitelist. The registered email user can use his/her user ID and password to log into the agent center and update the expiry date of the public agent or request a new public agent.

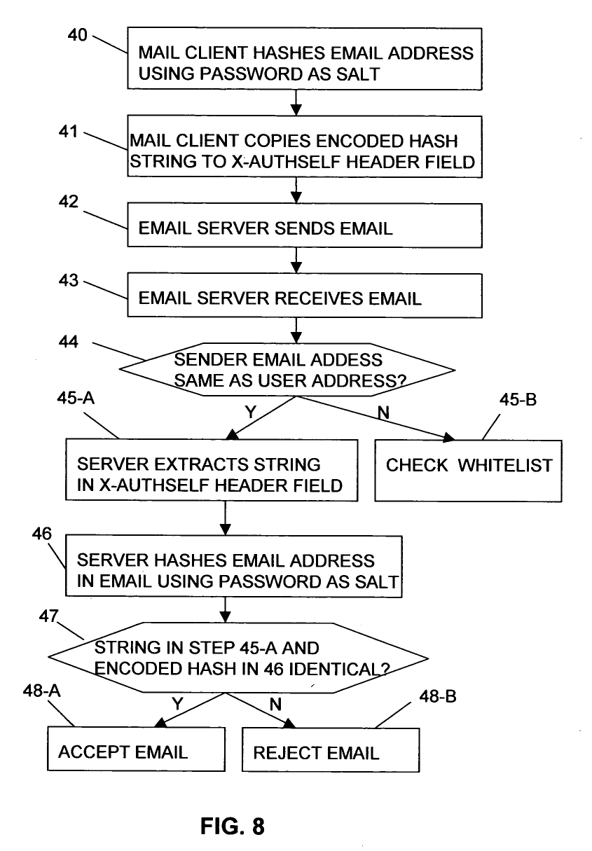

FIG. 8 is a flowchart illustrating the procedure and steps to block junk email messages in which the sender's email address is identical to the recipient's email address. In the whitelisting method, a user's email address must be included in his/her whitelist so that the user can send an email to himself/herself. However, it is often a junk-email sender's trick to fake an email and place the victim user's email address in the “From” header field so that the email appears to be sent from the email user himself/herself. In the illustrated embodiment of the present invention, the mail client used by the sender adds an extra mail header to the outgoing email if the email is addressed to the email user. The header field is named “X-AuthSelf”, which could be changed to a different name without affecting the true meaning of the field. When the mail server receives the email, it examines the X-AuthSelf header to determine whether the message is truly a “self-addressed” email. Detailed the steps of the procedure are described as follows.

At step 40, when an email user tries to send an email to himself/herself, the mail client uses a one-way hash function on his/her email address to obtain a hash string. A one-way hash function is also known as message digest, fingerprint, and compression function. A hash function is an algorithm that takes a variable-length string as input and produces a fixed-length binary value (hash) as the output. The critical part is to make this process irreversible, that is, finding a string that produces a given hash value should be very hard (hence the word “one-way”). It should also be hard to find two arbitrary strings that produce the same hash value. Algorithms MD4, MD5 and SHA-1 are commonly used hash algorithms. In the illustrated embodiment of this invention, the MD5 algorithm is used for one-way hashing of email addresses.

Since a junk-email sender can use the hash function on the user's email address to generate the same hash value, a piece of information that are unknown to the junk-email sender must be used in the hashing process. The present invention uses the password of the user's email account as the “salt” in the hash function. Salt is just a string that is concatenated with the input string before being operated on by the hash function. At step 40, the user's password is concatenated with the user's email address and the MD5 hash function is applied to the concatenated string. Using password as salt would prevent junk-email senders from obtaining the same hash value since they do not have the user's password.

At step 41, the mail client used by the email user adds the header field X-AuthSelf to the SMTP mail header and copies the base64-encoded value of the hash string obtained in step 40 to the field value. The header field-value pair is shown as follows:

X-AuthSelf: <base64 encoding of (MD5 hash of (password+emailaddress))>

where (password+emailaddress) represents the concatenated string of the user's email account password and his/her email address.

Base64 encoding is used because some SMTP mail servers on the Internet cannot process binary strings properly. Base64 encoding always produces US-ASCII strings so that the email can be transferred safely over the Internet.

At step 42 the user's mail server sends the email and at step 43 the server receives the email. Note that at step 43 the email server may receive email messages from other senders as well. At step 44, the mail server extracts the sender's email address (on the “From” header field) from the email and compare this address with the recipient's email address. If these two email addresses are not the same, the control goes to step 45-B where the sender's email address is searched in the email user's whitelist for junk email blocking according to the standard whitelisting method. If they are the same, then the server extracts the value of the “X-AuthSelf” header field in step 45-A. The value is empty if the header field does not exist in the email.

At step 46, the server uses the same hash function as that used in the step 40 to obtain the hash value of the concatenated string of the user's email account password and the user's email address. At step 47 the hash value is encoded by the base64 algorithm. At step 47, the base64-encoded string is compared with the X-AuthSelf header field extracted in the step 45-A to determine whether they are the same. If the answer is YES, then the email is an authentic email sent by the user himself/herself. If the answer is NO, then the email is rejected as a faked email.

In other embodiments of the invention, other hash functions such as MD4 and SHA-1 can be used at steps 40 and 47. The base64 algorithm used in the illustrated embodiment can be replaced by other binary-to-ASCII conversion algorithms such as the Quoted Printable (QP) encoding algorithm. As long as the same hash function and encoding algorithm are used in sending and receiving email, the procedure illustrated in FIG. 8 is valid for distinguishing fake and authentic email messages.

While the illustrated embodiment uses protocols such as HTTP and SMTP, the invention may also be used with other networking protocols such as IP version 6, SOAP, XML, Extended SMTP, or protocols not yet developed.

The invention may also be used with cryptographic protocols such as Secure Socket Layer (SSL), IP Security (IPSec), and Public Key Infrastructure (PKI). In the PKI architecture, a user holds two keys: a public key and a private key. An email sender uses a recipient's public key to encrypt a message and the recipient uses his/her own secret private key to decrypt the message. The public and private keys are also used to authenticate the origin of messages. Email messages sent using the PKI protocol are said to be “secure”.

Two well-known protocols of the PKI architecture are S/MIME and OpenPGP standards. S/MIME is short for Secure Multipurpose Internet Mail Extensions, which is a specification for secure electronic messaging. OpenPGP is short for Open Pretty Good Privacy and is another standard in secure electronic messaging. S/MIME and OpenPGP both build on top of the PKI architecture.

If email users use any one of the PKI protocols, then the following modifications are made to the illustrated embodiment of the present invention:

Referring to FIG. 5 that shows the process of an email user registering with an agent center, the user is required to enter his/her PKI public key or certificate following the step 28-A or 28-B but prior to the step 29. At step 29, the agent center also creates public and private keys of PKI for the public and private agents of the registered user. The agent center saves the public and private keys of both agents into the agent database and reveals the public key or certificate of the private agent to the registered user.

At step 21 in FIG. 4, the registered user obtains the public key of his/her private agent in addition to the email addresses of the agents. At step 22, the user “trusts” and saves the public key of the private agent into his/her whitelist.

Referring to FIG. 6, at step 32, if the email sender has a PKI public key, the sender can enter his/her public key along with the message text. When the recipient receives the email, email address and public key of the sender are both captured. At step 34, the agent center can use a security protocol such as S/MIME or OpenPGP to send email to the recipient.

In FIG. 7, at step 39, the agent center can send secure email to the recipient using S/MIME, OpenPGP, or any other secure communication protocol.

When an registered email user and the agent center use secure email communication, the agent database 9-B shown in FIG. 2 has the following additional parameters in the record of the registered user:

{UsersPublicKey, PrivateAgentsPublicKey, PrivateAgentsPrivateKey, PublicAgentsPublicKey, PublicAgentsPrivateKey}

where UsersPublicKey is the public key of the registered user. This is key is required for the agent center to send encrypted email to the user. PrivateAgentsPublicKey is the public key of the private agent. This key is as important as the email address of the private agent and should be protected by the registered user from disclosing to other email users. PrivateAgentsPrivateKey is the private key of the public agent. PublicAgentsPublicKey is the public key of the user's public agent. PublicAgentsPrivateKey is the private key of the public agent.

The described modifications are made so that secure email can be sent between the agent center and a registered email user as well as between a registered user and another registered or non-registered email user. The PKI keys are just additional information added in whitelist or agent database similar to email addresses.

Another modification that can be made to the illustrated embodiment is that the agent center and the user's email server can share user-profile information such as password, user's name. Sharing the information can be implemented by messaging between the agent center and the email server according to some communication protocol such as TCP/IP sockets, HTTP, SOAP, or any other protocol. Password sharing is particularly important because the users can be relieved from memorizing multiple passwords. Email servers usually have a user-account database that includes information such as user email address, account password, and user's name. If sharing of password is desired, the step 26 shown in FIG. 5 can be omitted and the agent center can obtain the password from the user-account database on the email server and save it into the agent database in the agent center.

In the illustrated embodiment, the private agent and the public agent are identified by associated email addresses. However, other communication addresses used by the private and public agents may include any sequence of one or more characters that uniquely identify a file, variable, account, or other entity. For example, the addresses may identify a node in a network by a data access control address, a media access control address or another type of IP address. In another embodiment, the public and private address may include a URL with an IP address or a domain name. In a further embodiment, the private and public agents use an instant message protocol and are identified with instant message contact addresses, such as, for example, instant inbox addresses. In still another embodiment, the private and public agents use a short message service protocol or a text message service protocol and are identified by a home location register of a subscriber's mobile device, such as a personal digital assistant, a cellular phone, or a pager.

While the present invention has been particularly described with reference to the preferred embodiments, it should be obvious to those of ordinary skill in the art that modifications in form and details may be made without departing from the spirit and scope of the invention.

I claim:

1. A method of screening a message, comprising:
conveying a first electronic message from a public address of a receiver to a private address of the receiver; and
delivering the conveyed first electronic message from the private address to a receiver address.

2. The method of claim 1, further comprising:
assigning the public address and the private address to the receiver.

3. The method of claim 1, further comprising:
terminating the public address after a time period.

4. The method of claim 3, further comprising:
rejecting a second message sent to the terminated public address.

5. The method of claim 3, further comprising:
replacing the terminated public address with a new unique public address.

6. The method of claim 1, further comprising:
assigning a unique mail uniform resource identifier to the receiver; and
receiving a third electronic message at the mail uniform resource identifier;
wherein the delivering further comprises delivering the third electronic message from the mail uniform resource identifier to the receiver address if a sender of the third message recognizes an image pattern.

7. The method of claim 6, further comprising:
presenting an online form to the sender, the online form including the image pattern;
wherein the delivering further comprises retrieving the private address associated with the mail uniform resource identifier and delivering the third electronic message to the receiver address with the private address as a sender address if the image pattern is recognized.

8. The method of claim 6, wherein the uniform resource identifier comprises a uniform resource locater.

9. The method of claim 1, further comprising:
registering the receiver having the receiver address; and
providing a user account to the registered receiver, wherein the user account comprises the private address and the public address.

10. The method of claim 9, wherein the providing the user account further comprises requesting entry of a unique user identification and a password and further comprising allowing access to the user account with the user identification and the password.

11. The method of claim 10, wherein the providing the user account further comprises:
determining whether the requested user identification is an email account to be protected; and
requesting an email address of the email account to be protected if the requested user identification is not the email account to be protected.

12. The method of claim 1, further comprising:
establishing a list of approved senders;
wherein the delivering further comprises only delivering a message if a sender is one of the approved senders.

13. The method of claim 12, further comprising:
including the private address in the list of approved senders.

14. The method of claim 12, wherein the list of approved senders comprises a whitelist.

15. The method of claim 1, wherein the first electronic message comprises an email message, the private address comprises a first email address, and the public address comprises a second email address.

16. A computer readable medium having embodied thereon a computer program for processing by a computer, the computer program comprising:
a first code segment to assign a unique mail uniform resource identifier and a unique private address to a receiver;
a second code segment to receive an electronic message at the mail uniform resource identifier; and
a third code segment to deliver the electronic message from the mail uniform resource identifier to an address of the receiver with a sender address that includes the private address if a sender of the third message recognizes an image pattern.

17. The computer readable medium of claim 16, wherein the uniform resource identifier comprises a uniform resource locater.

18. A message screening system, comprising:
a database having a list of approved senders;
an email agent module configured to provide an email user with a private agent having a private agent email address and a public agent having a public agent email address;
a mail transfer module that transfers an email message from the public agent to the private agent; and
a mail delivery module that delivers the email message from the private agent to an address of the email user if the private agent email address is included in the list of approved senders.

19. The system of claim 18, wherein the list of approved senders comprises a whitelist.

20. The system of claim 18, further comprising a uniform resource identifier module configured to deliver the email message to the private agent if a sender of the email message recognizes an image pattern.
